(19) United States
(12) Patent Application Publication
(10) Pub. No.: US 2013/0033507 A1
(43) Pub. Date: Feb. 7, 2013

(54) SYSTEM, METHOD, AND COMPUTER PROGRAM PRODUCT FOR CONSTRUCTING AN ACCELERATION STRUCTURE

(71) Applicants: Kirill Vladimirovich Garanzha, Moscow (RU); Jacopo Pantaleoni, Berlin (DE); David Kirk McAllister, Holladay, UT (US)

(72) Inventors: Kirill Vladimirovich Garanzha, Moscow (RU); Jacopo Pantaleoni, Berlin (DE); David Kirk McAllister, Holladay, UT (US)

(73) Assignee: NVIDIA Corporation, Santa Clara, CA (US)

(21) Appl. No.: 13/198,656

(22) Filed: Aug. 4, 2011

(51) Int. Cl. G06T 1/00

(52) U.S. Cl. 345/522

(57) ABSTRACT

A system, method, and computer program product are provided for constructing an acceleration structure. In use, a plurality of primitives associated with a scene is identified. Additionally, an acceleration structure is constructed, utilizing the primitives.

### FIELD OF THE INVENTION

The present invention relates to rendering images, and more particularly to performing ray tracing.

### BACKGROUND

Traditionally, ray tracing has been used to generate images within a displayed scene. For example, intersections between a plurality of rays and a plurality of primitives of the displayed scene may be determined in order to render images associated with the primitives. However, current techniques for performing ray tracing have been associated with various limitations.

For example, current methods for performing ray tracing may inefficiently construct acceleration structures used in association with the ray tracing. This may result in time-intensive construction of acceleration structures that are associated with large amounts of primitives.

There is thus a need for addressing these and/or other issues associated with the prior art.

### SUMMARY

A system, method, and computer program product are provided for constructing an acceleration structure. In use, a plurality of primitives associated with a scene is identified. Additionally, an acceleration structure is constructed, utilizing the primitives.

### BRIEF DESCRIPTION OF THE DRAWINGS

FIG. 1 shows a method for constructing an acceleration structure, in accordance with one embodiment.

FIG. 2 shows a task queue system used in performing partitioning during the construction of an acceleration structure, in accordance with another embodiment.

FIG. 3 shows a sorting of a group of primitives using Morton codes, in accordance with yet another embodiment.

FIG. 4 shows a plurality of middle-split queues corresponding to the sorting performed in FIG. 3, in accordance with yet another embodiment.

FIG. 5 shows a data flow visualization of a SAH binning procedure, in accordance with yet another embodiment.

FIG. 6 illustrates an exemplary system in which the various architecture and/or functionality of the various previous embodiments may be implemented.

### DETAILED DESCRIPTION

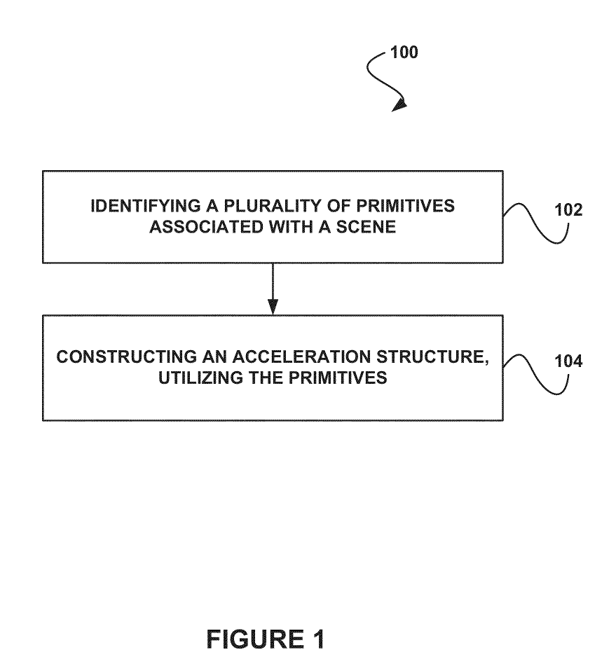

FIG. 1 shows a method 100 for constructing an acceleration structure, in accordance with one embodiment. As shown in operation 102, a plurality of primitives associated with a scene is identified. In one embodiment, the scene may include a scene that is in the process of being rendered. For example, the scene may be in the process of being rendered using ray tracing. In another embodiment, the plurality of primitives may be included within the scene. For example, the scene may be composed of the plurality of the primitives. In yet another embodiment, the plurality of primitives may include a plurality of triangles. Of course, however, the plurality of primitives may include any primitives used to perform ray tracing.

Additionally, as shown in operation 104, an acceleration structure is constructed, utilizing the primitives. In one embodiment, the acceleration structure may include a bounding volume hierarchy (BVH). In another embodiment, the acceleration structure may include a linearized bounding volume hierarchy (LBVH). In yet another embodiment, the acceleration structure may include a hierarchical linearized bounding volume hierarchy (HLBVH).

In another embodiment, the acceleration structure may include a plurality of nodes. For example, the acceleration structure may include a hierarchy of nodes, where child nodes represent bounding boxes located within respective parent node bounding boxes, and where leaf nodes represent one or more primitives that reside within respective parent bounding boxes. In this way, the acceleration structure may include a bounding volume hierarchy which may organize the primitives into a plurality of hierarchical boxes to be used during ray tracing.

Further, in one embodiment, constructing the acceleration structure may include sorting the primitives. For example, the primitives may be sorted along a space-filling curve (e.g., a Morton curve, a Hilbert curve, etc.) that spans a bounding box of the scene. In another embodiment, the space-filling curve may be determined by calculating a Morton code of a centroid of each primitive in the scene (e.g., an average location in the middle of the primitive may be transformed from three dimensional (3D) coordinates into a one dimensional coordinate associated with a recursively designed Morton curve, etc.).

In another example, the sorting may he performed utilizing a least significant digit radix sorting algorithm. In another embodiment, constructing the acceleration structure may include forming clusters of primitives (e.g., coarse cluster of primitives, etc.) within the scene. For example, the clusters may he formed utilizing a run-length encoding compression algorithm.

Further still, in one embodiment, constructing the acceleration structure may include partitioning primitives within each formed duster. For example, constructing the acceleration structure may include partitioning all primitives within each cluster using spatial middle splits (e.g. LBVH-style spatial middle splits, etc.). In another example, constructing the acceleration structure may include creating a tree (e.g., a top-level tree, etc.), utilizing the clusters. For example, constructing the acceleration structure may include creating a top-level tree by partitioning the clusters (e.g., utilizing a binned surface area heuristic (SAH), a SAH-optimized tree construction algorithm, etc.). In another embodiment, the SAH may utilize a parallel binning scheme.

Also, in one embodiment, partitioning the primitives and the clusters may be performed utilizing one or more task queues. For example, a task queue system may be used to parallelize work during the construction of the acceleration structure (e.g., by creating a pipeline, etc.). In another embodiment, the acceleration structure may be constructed utilizing one or more algorithms. For example, sorting the primitives, forming the dusters of the primitives, partitioning the primitives, and creating the tree may all be performed utilizing one or more algorithms.

Additionally, in one embodiment, constructing the acceleration structure may be performed utilizing a graphics processing unit (GPU). For example, a GPU may perform the entire construction of the acceleration structure. In this way, the transfer of data between the GPU and system memory associated with a central processing unit (CPU) may be avoided, which may decrease the time necessary to construct the acceleration structure.

More illustrative information will now be set forth regarding various optional architectures and features with which the foregoing framework may or may not be implemented, per the desires of the user. It should be strongly noted that the following information is set forth for illustrative purposes and should not be construed as limiting in any manner. Any of the following features may be optionally incorporated with or without the exclusion of other features described.

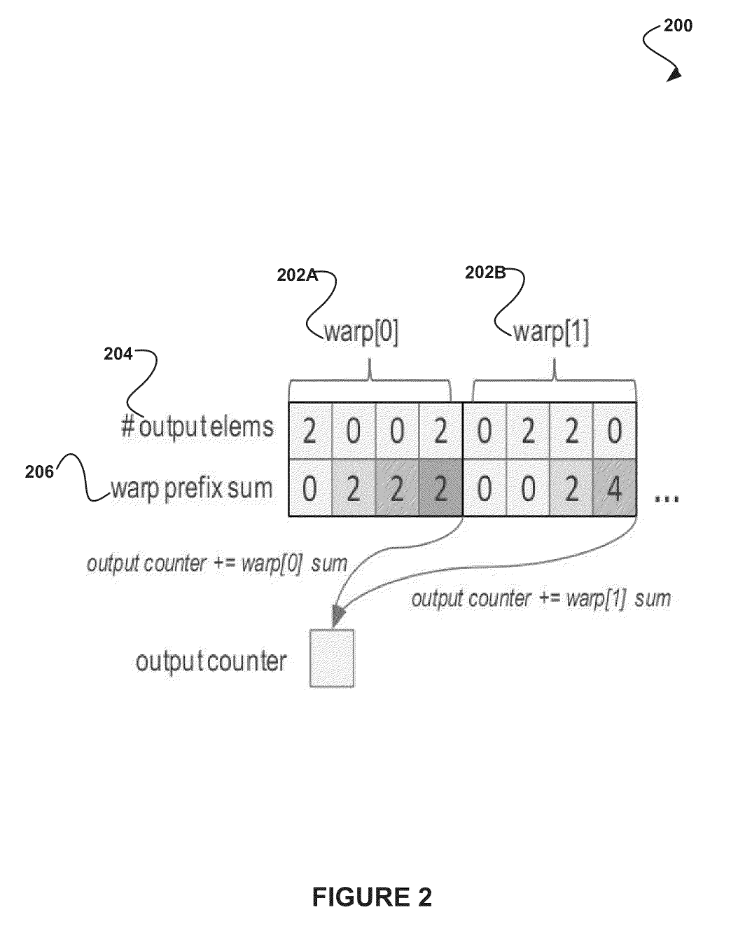

FIG. 2 shows a task queue system 200 used in performing partitioning during the construction of an acceleration structure, in accordance with another embodiment. As an option, the present task queue system 200 may be carried out in the context of the functionality of FIG. 1. Of course, however, the task queue system 200 may be implemented in any desired environment. It should also be noted that the aforementioned definitions may apply during the present description.

As shown, the task queue system 200 includes a plurality of warps 202A and 202B that each fetch sets of tasks to process (e.g., from an input queue, etc.). In one embodiment, each of the plurality of warps 202A and 202B may include a unit of work (e.g., a physical SIMT unit of work on a GPU, etc.). In another embodiment, each individual task may correspond to processing a single node during the construction of an acceleration structure.

Additionally, in one embodiment, at run time, each of the plurality of warps 202A and 202B may continue to fetch sets of tasks to process from the input queue, where each set may contain one task per thread. Additionally, each of the plurality of warps 202A and 202B may use a single global memory atomic add per warp to update the queue head. Further, each thread in each of the plurality of warps 202A and 202B computes a number of output tasks 204 that it will generate.

Further still, after each thread in each of the plurality of warps 202A and 202B has computed the number of output tasks 204 that it will generate, all threads in each of the plurality of warps 202A and 202B participate in a warp-wide prefix sum 206 to compute the offset of their output tasks relative to the common base of each of the plurality of warps 202A and 202B. In one embodiment, the first thread in each of the plurality of warps 202A and 202B may perform a single global memory atomic add to compute a base address in an output queue of the plurality of warps 202A and 202B. Also, in one embodiment, a separate queue may be used per level, which may enable all the processing to be performed inside a single kernel call, while at the same time producing a breadth-first tree layout.

In one embodiment, constructing the acceleration structure may include using one or more algorithms to create both a standard LBVH and a higher quality SAH hybrid. See, for example, “HLBVH: Hierarchical LBVH construction for real-time ray tracing of dynamic geometry,” (Pantaleoni et al., High-Performance Graphics 2010, ACM Siggraph/Eurographics Symposium Proceedings, Eurographics, 87-95), which is hereby incorporated by reference in its entirety, and which describes methods for constructing an LBVH and an HLBVH.

Additionally, in another embodiment, constructing the acceleration structure may include sorting primitives along a 30-bit Morton curve that spans a bounding box of a scene. See, for example, “Fast bvh construction on GPUs,” (Lauterbach et al., Comput. Graph. Forum 28, 2, 375-384), which is hereby incorporated by reference in its entirety, and which describes methods for sorting primitives and constructing BVHs. In yet another embodiment, the primitives may be sorted utilizing a brute force algorithm (e.g., a least-significant digit radix sorting algorithm, etc.).

In still another embodiment, utilizing an observation that Morton codes define a hierarchical grid, where each 3n bit code identifies a unique voxel in a regular grid with 2ⁿ entries per side, and where in one embodiment, the first 3m bits of the code identify the parent voxel in the coarser grid with 2^{m} subdivisions per side, coarse clusters of objects may be formed falling in each 3m bit bin. In another embodiment, the grid in which the unique voxel is identified may include different amounts of entries per side. In yet another embodiment, forming the coarse clusters of objects may be performed utilizing an instance of a run-length encoding compression algorithm, and may be implemented with a single compaction operation.

Further, in one embodiment, after the clusters are identified, all the primitives may be partitioned inside each cluster (e.g., using LBVH-style spatial middle splits, etc.). In another embodiment, a top-level tree may then be created, where the clusters may be partitioned with a binned SAH builder. See, for example, “On fast Construction of SAH based Bounding Volume Hierarchies,” (Wald, I., In Proceedings of the 2007 Eurographics/IEEE Symposium on Interactive Ray Tracing, Eurographics), which is hereby incorporated by reference in its entirety, and which describes methods for partitioning clusters.

Further still, in one embodiment, both the spatial middle split partitioning and the SAH builder may rely on an efficient task queue system (e.g., the task queue system 200, etc.), which may parallelize work over the individual nodes of the output hierarchies.

Also, in one embodiment, middle split hierarchy emission may be performed. For example, it may be noted that each node in the hierarchy may correspond to a consecutive range of primitives sorted by their Morton codes, and that splitting a node may require finding the first element in the range whose code differed from the preceding element. Additionally, in another embodiment, complex machinery may be avoided by reverting to a standard ordering that may be used on a serial device. For example, each node may be mapped to a single thread, and each thread may be allowed to find its own split plane.

In yet another embodiment, instead of looping through the entire range of primitives in the node, it may be observed that it is possible to reformulate the problem as a simple binary search. For example, it may be determined that if a node is located at a level l, the Morton codes of the primitives of the nodes may have the exact same set of high l−1 bits. In another embodiment, the first bit p≧l by which the first and last Morton code in the node's range differ may be determined. In still another embodiment, a binary search may be performed to locate the first Morton code that contains a 1 at bit p.

In this way, for a node containing N primitives, the algorithm may find the split plane by touching only O(log₂(N)) memory cells, instead of the entire set of N Morton codes.

Additionally, in one embodiment, middle splits may sometimes fail, which may lead to occasional large leaves. In another embodiment, when such a failure is detected, the leaves may be split by the object-median. In yet another embodiment, after the topology of the BHV has been computed, a bottom-up re-fitting procedure may be run to compute the bounding boxes of each node in the tree. This process may be simplified by the fact that the BVH is stored in breadth-first order. In another embodiment, one kernel launch may be used per tree level, and one thread may be used per node in the level.

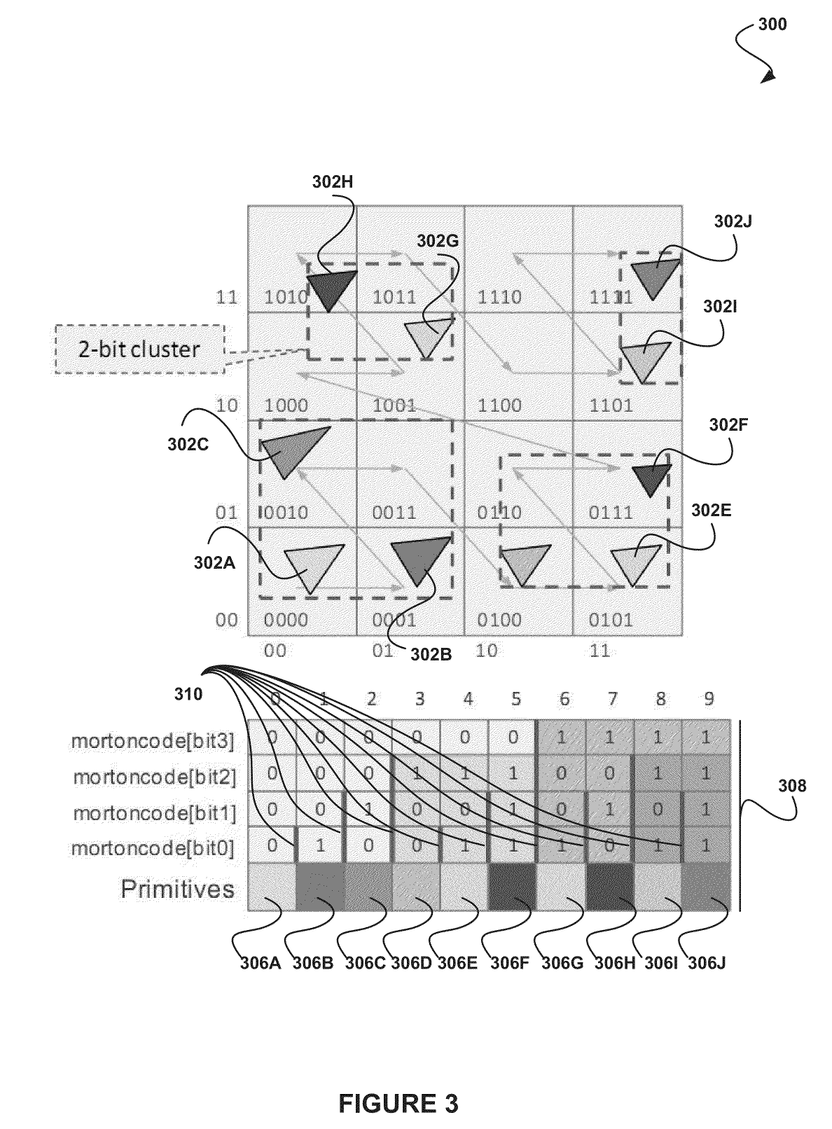

FIG. 3 shows a sorting 300 of a group of primitives using Morton codes, in accordance with another embodiment. As an option, the present sorting 300 may be carried out in the context of the functionality of FIGS. 1-2. Of course, however, the sorting 300 may be implemented in any desired environment. It should also be noted that the aforementioned definitions may apply during the present description.

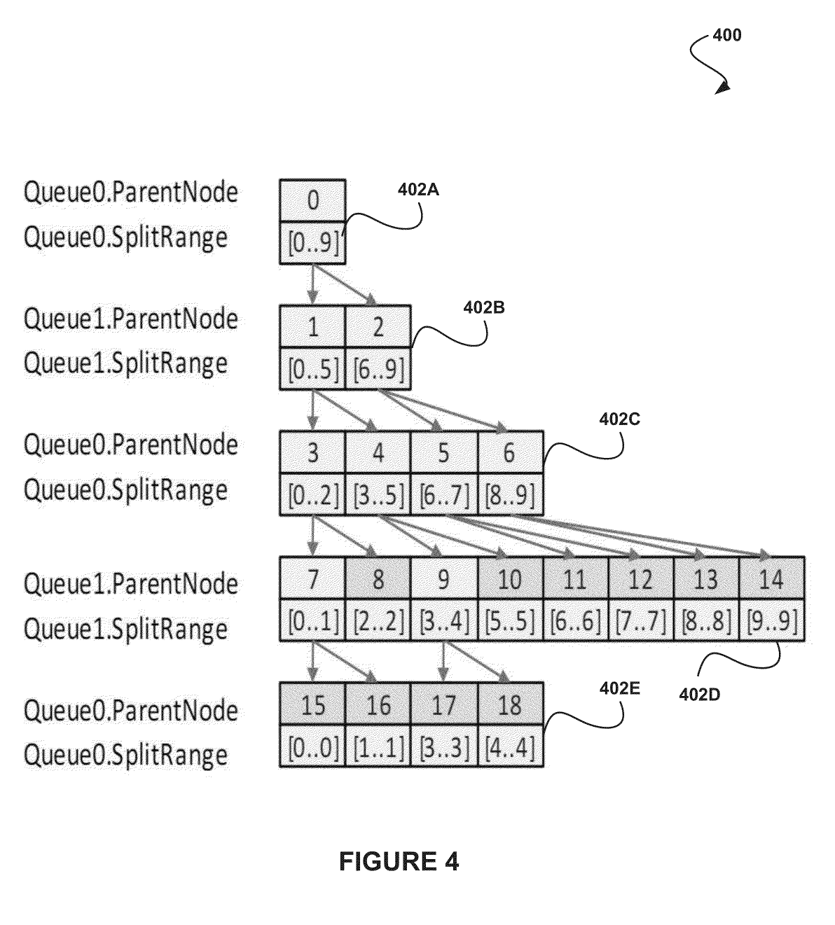

As shown, centroids of a plurality of bounded primitives 302A-J located within a two-dimensional projection are each assigned Morton codes (e.g., four-bit Morton codes, etc.). Additionally, the plurality of bounded primitives 302A-J are sorted into a sequence of rows 306 A-J, where the assigned Morton codes are used as keys. For example, for every respective primitive of sequence 306 A-J, the Morton code bits are shown in separate rows 308. Additionally, binary search partitions 310 are made to the sequence of rows 306 A-J. Further, FIG. 4 shows a plurality of middle-split queues 402A-E corresponding to the sorting 300 performed in FIG. 3, in accordance with another embodiment.

Additionally, in one embodiment, a SAH-optimized tree construction algorithm may be run over the coarse clusters defined by the first 3m bits of the Morton curve. In one embodiment, m may be between 5 and 7. Of course, however, m may include any integer. In another embodiment, the construction algorithm may run in a bounded memory footprint. For example, if N_{c} clusters are processed, space may he preallocated only for 2N_{c}−1 nodes.

Table 1 illustrates pseudo-code for the SAH binning procedure associated with the optimized tree construction algorithm. Of course, it should be noted that the pseudo-code shown in Table 1 is set forth for illustrative purposes only, and thus should not be construed as limiting in any manner.

TABLE 1

int qin = 0;
int numQElems = 1;
hltop_queue_init(queue[qin], Clusters, numClusters);
while(numQElems > 0)
{

// init all bins (empty bounding boxes, reset counters)
bins_init(queue[qin], numQElems);
// compute bin statistics
accumulate_bins(queue[qin], Clusters, numClusters);
int output_counter = 0;
// compute best splits
sah_split(

queue[qin], numQElems, queue[1−qin],
&output_counter, BvhReferences, numBvhNodes);

// distribute clusters to their new split task
distribute_clusters(

queue[qin], Clusters, numClusters);

numQElems = output_counter;
numBvhNodes += output_counter;
qin = 1 − qin;
BvhLevelOffset[numBvhLevels++] = numBvhNodes;

}

In one embodiment, in a pass, a cluster from the prior pass (with its aggregate bounding box) may be treated as a primitive. In another embodiment, the computation may be split into split tasks organized in a single input queue and a single output queue. In yet another embodiment, each task may correspond to a node that needs to be split, and may be described by three input fields (e.g., the node's bounding box, the number of clusters inside the node, and the node ID).

Additionally, in one embodiment, two additional nodes may be computed on the fly (e.g., the best split plane and the ID of the first child split task). In another embodiment, these fields may be stored in a structure of arrays (SOA) format, which may keep a number (e.g., five, etc.) of separate arrays indexed by a task ID. In yet another embodiment, an array (e.g., cluster_split_id, etc.) may be kept that maps each duster to the current node (i.e. split task, etc.) it belongs to, where the array may be updated with every splitting operation.

Further, in one embodiment, the loop in Table I may start by assigning all clusters to the root node, which may form a split-task 0. Then, for each loop iteration, binning, SAH evaluation, and cluster distribution steps may be performed. For example, each node's bounding box may be split into M (e.g., M including an integer such as eight, etc.) slab-shaped bins in each dimension. See, for example, “Ray Tracing Deformable Scenes using Dynamic Bounding Volume Hierarchies,” (Wald, et al., ACM Transactions on Graphics 26, 1, 485-493), which is hereby incorporated by reference in its entirety, and which describes methods for splitting node bounding boxes.

Further still, in another embodiment, a bin may store an initially empty bounding box and a count. In yet another embodiment, each cluster's bounding box may be accumulated into the bin containing its centroid, and the count of the number of clusters falling within the bin may be atomically incremented. In still another embodiment, this procedure may be executed in parallel across the clusters, where each thread may look at a single cluster and may accumulate its bounding box into the corresponding bin within the corresponding split-task, using atomic min/max to grow the bins' bounding boxes.

Also, in one embodiment, for each split-task in the input queue, the surface area metric may be evaluated for all the split planes in each dimension between the uniformly distributed bins, and the best one may be selected. In another embodiment, if the split-task contains a single cluster, the subdivision may be stopped; otherwise, two output split-tasks may be created, where bounding boxes corresponding to the left and right subspaces may be determined by the SAH split.

In addition, in one embodiment, the mapping between clusters and split-tasks may be updated, where each cluster may be mapped to one of the two output split-tasks generated by its previous owner. In order to determine the new split-task ID, the i-th cluster's bin id may be compared to the value stored in the best split field of the corresponding split-task. Table 2 illustrates pseudo-code for a comparison of the i-th cluster's bin id to the value stored in the best split field of the corresponding split-task. Of course, it should be noted that the pseudo-code shown in Table 2 is set forth for illustrative purposes only, and thus should not be construed as limiting in any manner.

TABLE 2

int old_id = cluster_split_id[i];
int bin_id = cluster_bin_id[i];
int split_id = queue[in].best_split[ old_id ];
int new_id = queue[in].new_task[ old_id ];
cluster_split_id[i] =

new_id + (bin_id < split_id ? 0 : 1);

Further, in one embodiment, there may be some flexibility in the order of the algorithm phases. For example, refitting may be performed separately for bottom-level and top-level phases to trade off cluster bounding box precision against parallelism.

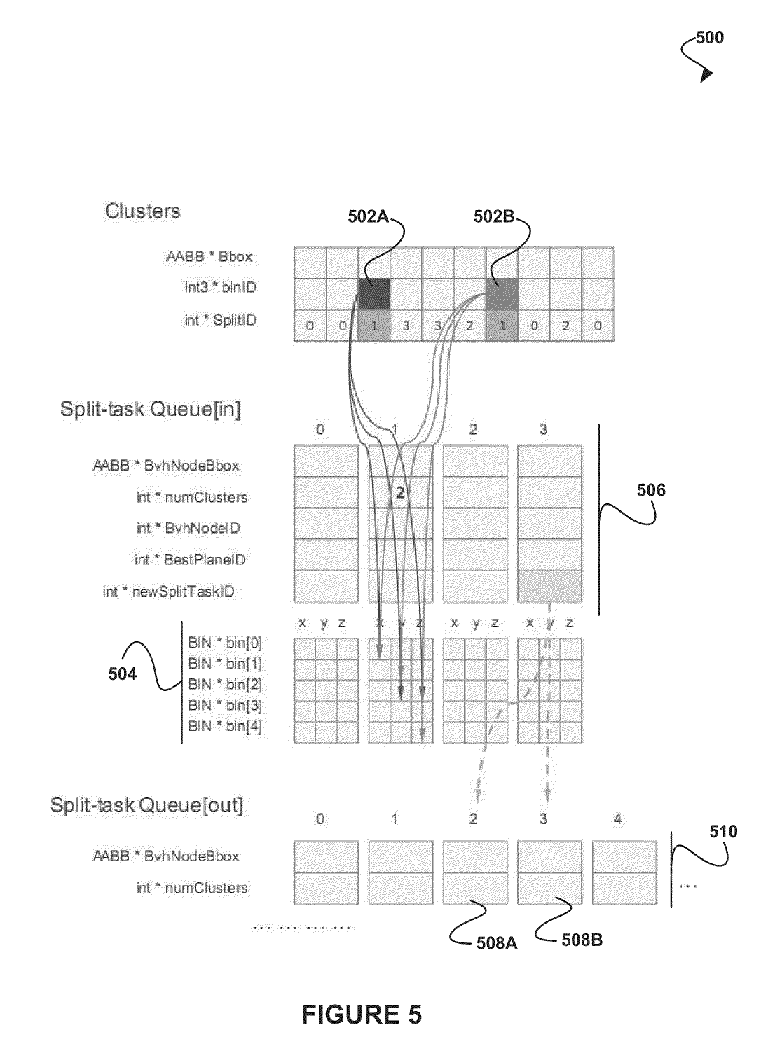

FIG. 5 shows a data flow visualization 500 of a SAH binning procedure, in accordance with another embodiment. As an option, the present data flow visualization 500 may be carried out in the context of the functionality of FIGS. 1-4. Of course, however, the data flow visualization 500 may be implemented in any desired environment, it should also be noted that the aforementioned definitions may apply during the present description.

As shown, clusters 502A and 502B contribute to forming the bin statistics 504 of their parent node. Additionally, nodes in the input task queue 506 are split, generating two entries 508A and 508B into the output queue 510.

Additionally, in one embodiment, specialized builders for clusters of fine intricate geometry (e.g., hair, fur, foliage, etc.) may be integrated. In another embodiment, this work may be easily integrated with triangle splitting strategies. See, for example, “Early split clipping for bounding volume hierarchies,” (Ernst, et al., Symposium on Interactive Ray Tracing 0, 73-78), which is hereby incorporated by reference in its entirety, and which describes triangle splitting strategies. In yet another embodiment, compress-sort-decompress techniques may be re-incorporated in order to exploit coherence internal to the mesh.

In this way, HLBVH may be implemented based on generic task queues, which may include a flexible paradigm of work dispatching that may he used to build simple and fast parallel algorithms. Additionally, in one embodiment, the same mechanism may be used to implement a massively parallel binned SAH builder for the high quality HLBVH variant. In another embodiment, the HLBVH implementation may be performed entirely on the GPU. In this way, synchronization and memory copies between CPU and CPU may be eliminated. For example, when considering the elimination of these overheads the resulting builder may be faster (e.g., 5-10 times faster, etc.) than previous techniques. In another example, when considering just the kernel times alone may also be faster (e.g., up to 3 times faster, etc.) than previous techniques.

Additionally, in one embodiment, high quality bounding volume hierarchies may be produced in real-time even for moderately complex models. In another embodiment, the algorithms may be faster than previous HLBVH implementations. This may be possible thanks to a general simplification offered by the adoption of work queues, which may allow a significant reduction in the number of high latency kernel launches and may reduce data transformation passes.

Further, in one embodiment, hierarchical linear bounding volume hierarchies (HLBVHs) may be able to reconstructing the spatial index needed for ray tracing in real-time, even in the presence of millions of fully dynamic triangles. In another embodiment, the aforementioned algorithms may enable a simpler and faster variant of HLBVH, where all the complex bookkeeping of prefix sums, compaction and partial breadth-first tree traversal needed for spatial partitioning may be replaced with an elegant pipeline built on top of efficient work queues and binary search. In yet another embodiment, the new algorithm may be both faster and more memory efficient, which may remove the need for temporary storage of geometry data for intermediate computations. Also, in one embodiment, the same pipeline may be extended to parallelize the construction of the top-level SAH optimized tree on the GPU, which may eliminate round-trips to the CPU, thereby accelerating the overall construction speed (e.g., by a factor of five to ten times,

In another embodiment, a novel variant of hierarchical linear bounding volume hierarchies (HLBVHs) may be provided that is simple, fast and easy to generalize. In one embodiment, an ad-hoc, complex mix of prefix-sums, compaction and partial breadth-first tree traversal primitives used to perform an actual object partitioning step may be replaced with a single, elegant pipeline based on efficient work-queues. In this way, the original HLBVH algorithm may be simplified, and superior speeds may be offered. Additionally, in one embodiment, the new pipeline may also remove the need for all additional temporary storage that may have been previously required.

Further still, in one embodiment, surface area heuristic (SAH) optimized HLBVH hybrid may be parallelized. For example, the added flexibility of a task-based pipeline may be combined with the efficiency of a parallel binning scheme. In this way, a speedup factor of up to ten times traditional methods may be obtained. Additionally, by parallelizing the entire pipeline, all acceleration structure construction may be run on the GPU, which may eliminate costly copies between a CPU and GPU memory spaces.

Also, in one embodiment, all algorithms used to construct the acceleration structure may be implemented using CUDA parallel computing architecture. See, for example, “Scalable parallel programming with coda,” (Nickolls, et al., ACM Queue 6, 2, 40-53), which is hereby incorporated by reference in its entirety, and which describes implementations of parallel computing with CUDA. Additionally, the construction of the acceleration structure may be performed utilizing efficient sorting primitives. See, for example, “Revisiting sorting for GPGPU stream architectures,” (Merrill, et al., Tech. Rep, CS2010-03, Department of Computer Science, University of Virginia, February), which is hereby incorporated by reference in its entirety, and which describes efficient sorting primitives.

Additionally, in one embodiment, the acceleration structure may include constructing a BVH. For example, a 3D extent of a scene may be discretized using n bits per dimension, and each point may be assigned a linear coordinate along a space-filling Morton curve of order n (which may be computed by interleaving the binary digits of the discretized coordinates). In another embodiment, primitives may then be sorted according to the Morton code of their centroid. In still another embodiment, the hierarchy may be built by grouping the primitives in clusters with the same 3n bit code, then grouping the clusters with the same 3(n−1) high order bits, and so on, until a complete tree is built. In yet another embodiment, the 3m high order bits of a Morton code may identify the parent voxel in a coarse grid with 2^{m} divisions per side, such that this process may correspond to splitting the primitives recursively in the spatial middle, from top to bottom.

Further, in one embodiment, HLBVH may improve on the basic algorithm in multiple ways. For example, it may provide a faster construction algorithm applying a compress-sort-decompress strategy to exploit spatial and temporal coherence in the input mesh. In another example, it may introduce a high-quality hybrid builder, in which the top of the hierarchy is built using a Surface Area Heuristic (SAH) sweep builder over the clusters defined by the voxelization at level in. See, for example, “Automatic creation of object hierarchies for ray tracing,” (Goldsmith, et al., IEEE Computer Graphics and Applications 7, 5, 14-20), which is hereby incorporated by reference in its entirety, and which describes an exemplary SAH.

In another embodiment, a custom scheduler may be built based on task-queues to implement a light-weight threading model, which may avoid overheads of built in hardware threads support. See, for example, “Fast Construction of SAH BVHs on the Intel Many Integrated Core (MIC) Architecture,” (Wald, I., IEEE Transactions on Visualization and Computer Graphics, which is hereby incorporated by reference in its entirety, and which describes a parallel binned-SAH BVH builder optimized for a prototype many core architecture.

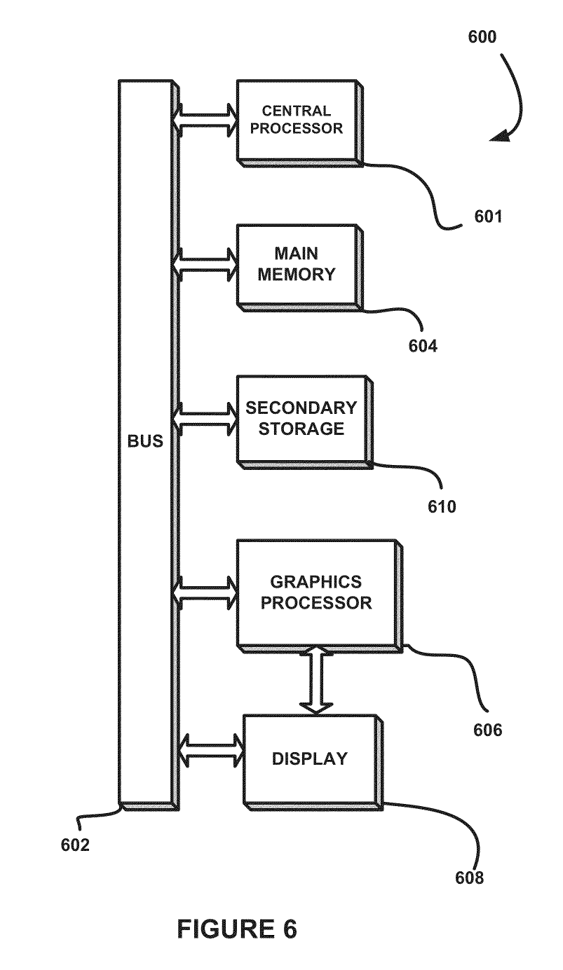

FIG. 6 illustrates an exemplary system 600 in which the various architecture and/or functionality of the various previous embodiments may be implemented. As shown, a system 600 is provided including at least one host processor 601 which is connected to a communication bus 602. The system 600 also includes a main memory 604. Control logic (software) and data are stored in the main memory 604 which may take the form of random access memory (RAM).

The system 600 also includes a graphics processor 606 and a display 608, i.e. a computer monitor. In one embodiment, the graphics processor 606 may include a plurality of shader modules, a rasterization module, etc. Each of the foregoing modules may even be situated on a single semiconductor platform to form a graphics processing unit (GPU).

In the present description, a single semiconductor platform may refer to a sole unitary semiconductor-based integrated circuit or chip. It should be noted that the term single semiconductor platform may also refer to multi-chip modules with increased connectivity which simulate on-chip operation, and make substantial improvements over utilizing a conventional central processing unit (CPU) and bus implementation. Of course, the various modules may also be situated separately or in various combinations of semiconductor platforms per the desires of the user.

The system 600 may also include a secondary storage 610. The secondary storage 610 includes, for example, a hard disk drive and/or a removable storage drive, representing a floppy disk drive, a magnetic tape drive, a compact disk drive, etc. The removable storage drive reads from and/or writes to a removable storage unit in a well known manner.

Computer programs, or computer control logic algorithms, may be stored in the main memory 604 and/or the secondary storage 610. Such computer programs, when executed, enable the system 600 to perform various functions. Memory 604, storage 610 and/or any other storage are possible examples of computer-readable media.

In one embodiment, the architecture and/or functionality of the various previous figures may be implemented in the context of the host processor 601, graphics processor 606, an integrated circuit (not shown) that is capable of at least a portion of the capabilities of both the host processor 601 and the graphics processor 606, a chipset (i.e. a group of integrated circuits designed to work and sold as a unit for performing related functions, etc.), and/or any other integrated circuit for that matter.

Still yet, the architecture and/or functionality of the various previous figures may be implemented in the context of a general computer system, a circuit board system, a game console system dedicated for entertainment purposes, an application-specific system, and/or any other desired system. For example, the system 600 may take the form of a desktop computer, lap-top computer, and/or any other type of logic. Still yet, the system 600 may take the form of various other devices in including, but not limited to a personal digital assistant (IDA) device, a mobile phone device, a television, etc.

Further, while not shown, the system 600 may be coupled to a network [e.g. a telecommunications network, local area network (LAN), wireless network, wide area network (WAN) such as the Internet, peer-to-peer network, cable network, etc.) for communication purposes.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method, comprising:
identifying a plurality of primitives associated with a scene; and
constructing an acceleration structure, utilizing the primitives.

2. The method of claim 1, wherein the scene is composed of the plurality of the primitives.

3. The method of claim 1, wherein a graphics processing unit (GPU) performs the entire construction of the acceleration structure.

4. The method of claim 1, wherein the acceleration structure includes a hierarchical linearized bounding volume hierarchy (HLBVH).

5. The method of claim 1, wherein the acceleration structure includes a plurality of nodes.

6. The method of claim 5, wherein the acceleration structure includes a hierarchy of nodes, where child nodes represent bounding boxes located within respective parent node bounding boxes, and where leaf nodes represent one or more primitives that reside within respective parent bounding boxes.

7. The method of claim 1, wherein constructing the acceleration structure includes sorting the primitives.

8. The method of claim 7, wherein the primitives are sorted along a space-filling curve that spans a bounding box of the scene.

9. The method of claim 8, wherein the space-filling curve is determined by calculating a Morton code of a centroid of each primitive in the scene.

10. The method of claim 1, wherein the sorting is performed utilizing a least significant digit radix sorting algorithm.

11. The method of claim 1, wherein constructing the acceleration structure includes forming clusters of primitives within the scene.

12. The method of claim 11, wherein the clusters are formed utilizing a run-length encoding compression algorithm.

13. The method of claim 11, wherein constructing the acceleration structure includes partitioning primitives within each formed cluster.

14. The method of claim 11, wherein constructing the acceleration structure includes partitioning all primitives within each cluster using spatial middle splits.

15. The method of claim 11, wherein constructing the acceleration structure includes creating a tree, utilizing the clusters.

16. The method of claim 14, wherein constructing the acceleration structure includes creating a top-level tree by partitioning the clusters.

17. The method of claim 16, wherein partitioning the primitives and the clusters is performed utilizing one or more task queues.

18. A computer program product embodied on a computer readable medium, comprising:
code for identifying a plurality of primitives associated with a scene; and
code for constructing an acceleration structure, utilizing the primitives.

19. A system, comprising:
a graphics processing unit (GPU) for identifying a plurality of primitives associated with a scene, and constructing an acceleration structure, utilizing the primitives.

20. The system of claim 19, further comprising memory coupled to the GPU via a bus.
